(19) United States
(12) Patent Application Publication
(10) Pub. No.: US 2026/0203586 A1
(43) Pub. Date: Jul. 16, 2026

(54) METHOD FOR AUTOMATIC INTERPRETATION OF SEMANTIC SEARCH RESULTS BASED ON RELEVANCE LEVELS

(71) Applicant: VIETTEL GROUP, Ha Noi City (VN)

(72) Inventors: PHAT TRIEN THAI, Tay Ninh Province (VN); HUU DOANH NGUYEN, Quang Ngai Province (VN); VAN TUAN NGUYEN, Nghe An Province (VN)

(73) Assignee: VIETTEL GROUP, Ha Noi City (VN)

(21) Appl. No.: 19/433,730

(22) Filed: Dec. 27, 2025

(30) Foreign Application Priority Data
Dec. 27, 2024 (VN) 1-2024-09785

(51) Int. Cl. G06N 3/084; G06F 18/21; G06F 18/22; G06F 40/30; G06N 3/0455

(52) U.S. Cl. CPC G06N 3/084; G06F 18/217; G06F 18/22; G06F 40/30; G06N 3/0455

(57) ABSTRACT

A method for automatic interpretation of semantic search results based on relevance levels. The method comprises four steps: step 1: retrieving reference data; step 2: generating interpretive data; step 3: training an interpretive model; step 4: generating interpretations and computing relevance levels. The proposed method enhances the retrieval performance by re-ranking or filtering low-relevance results and can be effectively applied in semantic text search systems and natural language processing applications requiring relevance evaluation and explainability.

### TECHNICAL ASPECTS OF THE INVENTION

The present invention introduces a method for automatically interpreting and evaluating the relevance of textual search results. The invention enhances the retrieval performance by re-ranking or filtering results with low relevance scores. The proposed technical solution is applicable to the field of natural language processing (NLP), particularly in semantic text search systems.

### BACKGROUND OF THE INVENTION

In the information age, rapid access to relevant information is essential across most domains. For textual data, keyword-based and semantic-based information retrieval systems have been developed to address this need. However, when searching within large data spaces, the retrieved results may not accurately reflect the user's intent or may include excessive irrelevant information. To address this issue, re-ranking or filtering modules are introduced to re-assess the relevance between the user query and the retrieved passages. This improves retrieval performance and allows customization of ranking intention for domain-specific applications. For example, given the user query “Internet connection error on computer ABC”, the initial retrieval results may include: (“Internet connection error on computer DEF”, 0.981); (“Computer ABC cannot access the network”, 0.762); (“External hard drive connection error on computer ABC”, 0.662); (“Computer ABC—display error”, 0.531). After re-evaluation by the proposed method, the adjusted results may become: (“Computer ABC cannot access the network”, 0.977); (“Internet connection error on computer DEF”, 0.432); (“External hard drive connection error on computer ABC”, 0.336); (“Computer ABC—display error”, 0.216). In this case, the most relevant passage (“Computer ABC cannot access the network”) is correctly ranked highest. A threshold value t (e.g., t=0.5) may also be applied to filter out irrelevant results.

Existing semantic search systems mainly focus on generating a relevance score for each query-passage pair, often using cross-encoder architectures that produce numerical scores without interpretation. Consequently, such models lack the ability to explain or justify ranking decisions. The present invention extends this approach by introducing an interpretive generation component based on an encoder-decoder language model. This addition enables both relevance scoring and human-readable explanations. The interpretive generation improves retrieval performance by learning linguistic features specific to each domain and focusing on key semantic content. It also increases transparency by revealing the reasoning behind relevance scores and facilitates training data generation using smaller annotated corpora expanded automatically via large language models (LLMs).

### SUMMARY OF THE INVENTION

The purpose of the invention is to provide a method for automatically interpreting and evaluating the relevance of semantic search results. The method comprises four main steps:
Step 1: reference data retrieval, wherein a reference dataset is defined by domain experts. Given a set of query-passage pairs to be annotated for relevance, this step retrieves similar data samples from the reference dataset to serve as examples for subsequent steps.
Step 2: interpretive data generation, wherein this step automatically generates interpretive training data using large language models (LLMs). For each query-passage pair and the examples retrieved in Step 1, a structured instruction prompt is constructed and fed into the LLM. The output includes an interpretation text and a relevance level for each current pair.
Step 3: training the interpretive model, wherein a smaller encoder-decoder language model is fine-tuned on the dataset produced in Step 2. The model learns to jointly generate explanations and predict relevance levels.
Step 4: inference for interpretation and relevance level estimation, wherein this step applies the trained interpretive model to new semantic search results. The input comprises query-passage pairs obtained from prior retrieval. The output includes a normalized relevance level and a textual explanation corresponding to each pair.

### BRIEF DESCRIPTION OF THE DRAWINGS

FIG. 1 illustrates the overall workflow of the proposed automatic interpretation method for semantic search results based on relevance levels;

FIG. 2 illustrates the process of retrieving reference data to obtain examples for training data generation using large language models;

FIG. 3 illustrates the process of generating interpretive outputs using the LLM based on query-passage pairs and example data; and

FIG. 4 illustrates the training process of the interpretive model under the encoder-decoder architecture using the constructed dataset.

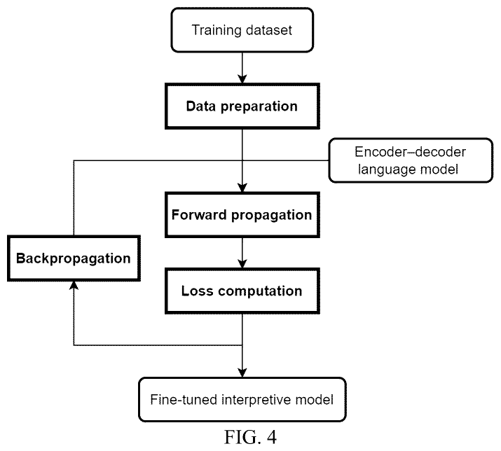

### DETAILED DESCRIPTION OF THE PREFERRED EMBODIMENT

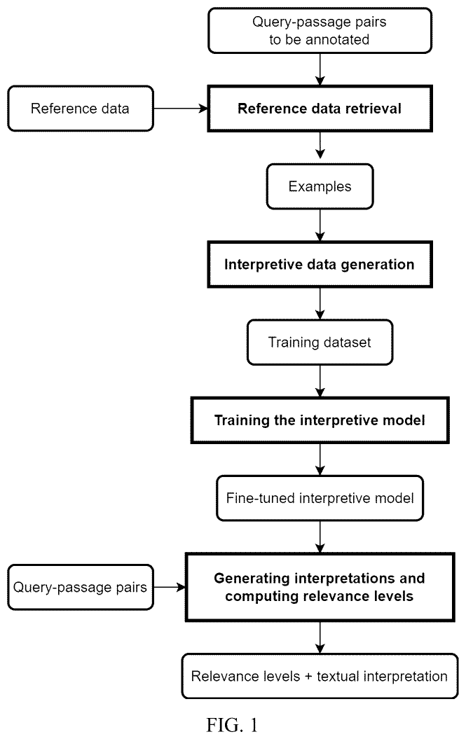

The invention provides a method for automatic interpretation of semantic search results based on relevance levels, as illustrated in FIG. 1. The method comprises four main steps:

### Step 1: Reference Data Retrieval;

Reference data refer to datasets defined by domain experts. This step is configured to provide representative examples for subsequent steps, enabling the construction of training data automatically.

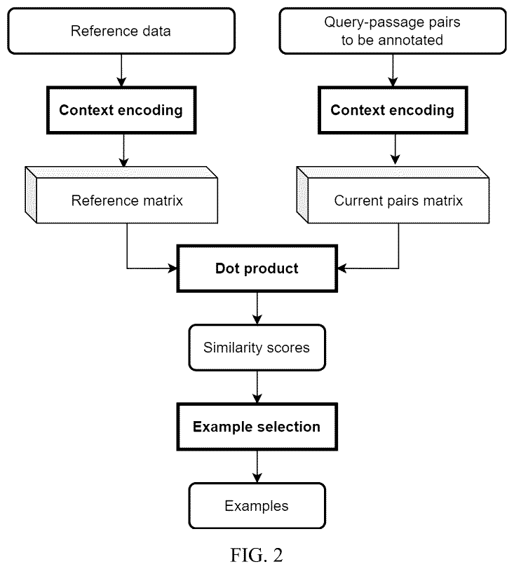

The processing flow of Step 1 is illustrated in FIG. 2. The inputs of this step comprise a reference dataset, and a set of query-passage pairs requiring automatic relevance annotating. The reference dataset contains both input information (query-passage pairs) and output information (relevance level annotations and corresponding interpretations). Each reference data point is annotated with a relevance level: 1 indicates relevant, and 0 indicates not relevant. These labels are pre-annotated by domain experts in data analysis to suite the intended applications or business requirements. In addition to relevance level evaluating, the annotators are required to provide textual explanations describing why a given query-passage pair is or is not relevant.

Each sample in the reference dataset takes the form of (query q, passage p, explanation e, relevance level r). Examples:

```
  (q = “Internet connection error on computer ABC”, p = “Internet connection
error on computer DEF”, e = “The passage refers to a different device (DEF)
rather than ABC, hence it is not relevant.”, r = 0)
  (q = “Internet connection error on computer ABC”, p = “Computer ABC
cannot access the network”, e = “Both refer to the same network connection error
on computer ABC.”, r = 1)
```

The output of Step 1 is a set of examples, i.e., data items in the reference dataset that are semantically similar to the given query-passage pair. This step comprises the following sub-steps:

Context encoding: This sub-step employs a bidirectional context encoder model E to transform each input text into an embedding vector that represents its semantic information. Let the reference dataset S include N samples:

$$S = \{ {s}_{1} , {s}_{2} , … , {s}_{N} \} = \{ ( {q}_{1} , {p}_{1} , {e}_{1} , {r}_{1} ) , ( {q}_{2} , {p}_{2} , {e}_{2} , {r}_{2} ) , … , ( {q}_{N} , {p}_{N} , {e}_{N} , {r}_{N} ) \}$$

Each query-passage pair (qᵢ, pᵢ) is encoded by the model E into a context embedding vᵢ. The embeddings of all samples form the reference matrix M_{S}:

$${M}_{s} = [ {v}_{1} , {v}_{2} , … , {v}_{N} ] = E ( S ) = E ( \{ ( {q}_{1} , {p}_{1} ) , ( {q}_{2} , {p}_{2} ) , … , ( {q}_{s} , {p}_{s} ) \} )$$

Similarly, the new query-passage pair (p, q) to be annotated is encoded into a vector v:

$$v = E ( p , q )$$

Dot product similarity: The embedding v is compared with all embeddings in the reference matrix M_{S} using the dot product operation to obtain a similarity score vector D:

$$D = [ {d}_{1} , {d}_{2} , … , {d}_{i} , … , {d}_{N} ] = {M}_{S} v = [ {v}_{1} \cdot v , {v}_{2} \cdot v , … , {v}_{i} \cdot v , … , {v}_{N} \cdot v ]$$

where each element dᵢ represents the similarity score between the current pair (p, q) and a reference sample (qᵢ, pᵢ) in S.

Example selection: The selection module identifies k samples from S that are most similar to (p, q) based on the computed similarity scores. To avoid bias toward a single relevance level, the selection ensures that

$$\frac{k}{2}$$

samples are chosen from relevant data (rᵢ=1) and

$$\frac{k}{2}$$

samples from non-relevant data (rᵢ=0), according to the highest similarity values dᵢ. The final selected set is defined as:

$$Top - ( \frac{k}{2} ) ( \{ {s}_{i} ∈ S \vert {r}_{i} = 1 \} , {v}_{i} \cdot v ) ⋃ Top - ( \frac{k}{2} ) ( \{ {s}_{i} ∈ S \vert {r}_{i} = 0 \} , {v}_{i} \cdot v )$$

where Top-k({x₁, x₂, . . . , x_{N}}, f(x)) denotes a function that retrieves the k elements with the highest scores according to f(x) from the set {x₁, x₂, . . . , x_{N}}; in this case, f(x) represents the dot product between the embedding of a reference sample vᵢ and the embedding of the current input v, as precomputed and stored in D.

After this step, the result is a balanced example set containing

$$\frac{k}{2}$$

relevant and

$$\frac{k}{2}$$

non-relevant samples, which will be used as reference examples in the subsequent data generation step.

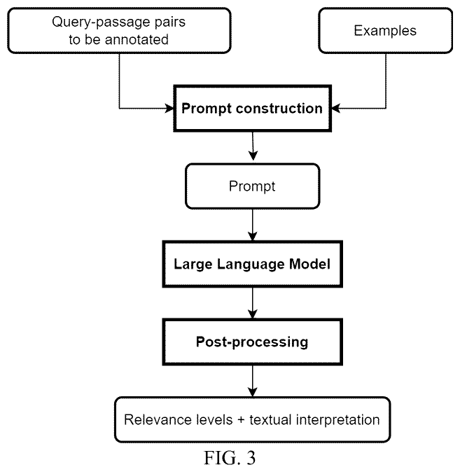

Step 2: interpretive data generation. The purpose of this step is to automatically generate training data using LLMs. Given each current query-passage pair and the reference examples obtained from Step 1, this step constructs a prompt to be fed into the large language model. The LLM then produces an interpretation and a relevance evaluation for each input pair. This step includes three sub-steps, as illustrated in FIG. 3:

Prompt construction: The prompt is a natural-language instruction document designed to guide the large language model in producing outputs that satisfy user-defined requirements. The prompt has a structured composition including the following components:
+ System instruction: specifies the role or perspective that the large language model must adopt, and general behavioral constraints.
+ User instruction: defines the specific task that the model must perform.
+ Output constraint: defines the required output format (e.g., JSON, YAML).
+ Examples: provide reference samples obtained from Step 1 for in-context learning.
+ Target data: contains the current query and passage pair to be annotated.

### Example in Information Technology (IT) Support Domain:

| | |
|---|---|
| System | You are a technical support engineer specializing in |
| instruc- | information technology. Your role is to troubleshoot and resolve |
| tion | IT-related issues in an enterprise environment. |
| User | You are provided with a user issue (problem) and an |
| instruc- | instruction (suggested solution). Evaluate and classify the |
| tion | relevance between the issue and the instruction into two levels: 1 |
| | for relevant, 0 for not relevant. |
| Output | Generate the result in JSON format as follows: |
| con- | {“explanation”: “<reason why relevant or not relevant>”, |
| straint | “label”: <1 or 0>} |
| Exam- | You may refer to the following examples: |
| ples | ----- |
| | Issue: Internet connection error on computer ABC |
| | Instruction: Internet connection error on computer DEF |
| | Output: {“explanation”: “The passage refers to an Internet |
| | connection error on computer DEF rather than on computer |
| | ABC, therefore it is not relevant.”, “label”: 0} |
| | ----- |
| | Issue: Internet connection error on computer ABC |
| | Instruction: Computer ABC cannot access the network |
| | Output: {“explanation”: “Both refer to the same network |
| | connectivity issue on computer ABC.”, “label”: 1} |
| Target | Now It's your turn. |
| data | Issue: Local network connection error on computer ABC |
| (to be | Instruction: Internet connection error on computer DEF |
| anno- | Output: |
| tated) | |

Large Language Model processing: The entire constructed prompt is fed into a pretrained large language model, which automatically generates the desired output. Each query-passage pair is processed multiple times, since LLM outputs may vary across different generations. For instance, the output corresponding to the above example may be: (“explanation”: “The passage describes an Internet connection error on computer DEF, not the local network issue on computer ABC.”, “label”: 0}.

Post-processing: A post-processing module is applied to ensure the quality and consistency of the generated dataset. This step filters out invalid or inconsistent samples based on the following criteria:
+ Format validation: to remove results that do not satisfy the required output format or are missing required fields such as “explanation” or “label”.
+ Label consistency filtering: for input pairs that produce multiple outputs across different LLM runs, only samples with consistent or majority labels are retained.

For example, if a particular input pair produces 8 results labeled “1” and 2 results labeled “0”, one of the eight samples with label “1” may be randomly selected for inclusion in the training dataset.

Step 3: training the interpretive model. This step is configured to fine-tune a smaller language model based on an encoder-decoder architecture using the training dataset prepared in Step 2. Although the large language model in Step 2 is capable of generating interpretations and relevance evaluations for each query-passage pair, deploying such a model in practical semantic search systems would incur high computational costs and latency. Therefore, a smaller language model is fine-tuned to achieve comparable accuracy with significantly lower deployment cost and response time.

The input of this step is the training dataset generated from Step 2, and the output is a fine-tuned interpretive model.

Before training, the dataset is reformatted into two text sequences for each sample:
+ Input text sequence: a concatenated text that combines the query q and the passage p in the format:

$$i = \begin{matrix}\text{"} {i}_{1} & {i}_{2} & {i}_{3} & … & {i}_{m} = q \vert p \text{"}\end{matrix}$$

where m denotes the number of tokens in the input sequence.
+ Output text sequence: a concatenated text containing the relevance label r and the explanation e in the following format:

$$o = \begin{matrix}\text{"} {o}_{1} & {o}_{2} & {o}_{3} & … & {i}_{n} \text{"}\end{matrix} = \{ \begin{matrix}[ spec 1 ] e [ eos ] & if r = 1 \\ [ spec 0 ] e [ eos ] & if r = 0\end{matrix}$$

where [spec0] and [spec1] are special tokens added to the model vocabulary to indicate the relevance class (o₁=[spec0] or [spec1]), n is the number of tokens in the output sequence; [eos] marks the end of the sequence.

Given a data sample with: q=“Local network connection error on computer ABC”; p=“Internet connection error on computer DEF”; e=“The passage refers to an Internet connection error on computer DEF rather than on computer ABC, therefore not relevant.”; r=0; the formatted training data becomes:

| | |
|---|---|
| Input text | Local network connection error on computer ABC |
| sequence | Internet connection error on computer DEF |
| Output | [spec0] The passage refers to an Internet connection error |
| text | on computer DEF rather than on computer ABC, therefore not |
| sequence | relevant. [eos] |

The interpretive model is based on an encoder-decoder language model architecture. The encoder receives the input token sequence “i₁ i₂ i₃ . . . iₘ” and transforms it into a set of hidden vectors representing the semantic features of the input [vi₁, vi₂, vi₃, . . . , viₘ]. The decoder receives the shifted target sequence “[pad]o₁ o₂ o₃ . . . oⱼ₋₁” (where [pad] is a special start token) and predicts the next token oⱼ at each step.

Each training epoch consists of the following operations:

Forward propagation: The input text sequence is first encoded by the encoder into contextual hidden vectors. The decoder then receives both the encoder's hidden states and the shifted output tokens, generating one token prediction at a time. At each decoding step j∈[1, n], the decoder outputs a probability distribution over the vocabulary representing the likelihood of each possible next token oⱼ.

Loss computation: After producing the predicted sequence, the model's output is compared with the ground truth to compute a loss value. The training uses the cross-entropy loss function, defined as:

$$L = - \frac{1}{n} {\sum }_{j = 1}^{T} log ( {ô}_{t , {o}_{j} )}$$

where n is the number of tokens in the output sequence; of is the target token at position j; ô_{t,o}_{ⱼ} is the predicted probability of the target token of at step j.

Backpropagation: During backpropagation, gradients of the loss function are computed and propagated backward through the decoder and encoder layers. The training process is repeated for multiple epochs (full iterations over the entire training dataset) until convergence is achieved—i.e., when the loss function no longer decreases significantly or reaches a predefined threshold.

Step 4: generating interpretations and computing relevance levels. The purpose of this step is to perform inference using the fine-tuned interpretive model obtained from Step 3. The input to this step is a set of query-passage pairs that require relevance evaluation. The output includes a normalized relevance level for each input pair, and a corresponding textual interpretation explaining the relationship between the query and the passage.

The inference process follows a forward propagation procedure similar to that used in Step 3. The encoder input is the concatenated text sequence

$$i = \begin{matrix}\text{"} {i}_{1} & {i}_{2} & {i}_{3} & … & {i}_{m} = q \vert p \text{"}\end{matrix}$$

where q denotes the current query and p denotes the current passage.

The decoder receives two inputs: the encoded hidden representations from the encoder, and the shifted target sequence, initially containing only the special token=“[pad]”.

The first decoder output is used to compute the relevance score between the query q and the passage p. Only two special tokens are considered: [spec0] and [spec1], representing the two relevance classes. Let the unnormalized logits (i.e., decoder output scores) corresponding to these tokens be ŷ_{1,[spec0]} and ŷ_{1,[spec1]}. The normalized relevance level r (ranging from 0 to 1) is computed as follows:

$$\hat{r} = \frac{{e}^{{\hat{y}}_{1 , [ spec 1 ]}}}{{e}^{{\hat{y}}_{1 , [ spec 0 ]}} + {e}^{{\hat{y}}_{1 , [ spec 1 ]}}}$$

In practical semantic search systems, this value r can be used directly as the relevance confidence level. The inference process may terminate at this point when textual interpretation is not required or when the system demands real-time response. When interpretive output is desired, the decoding process continues iteratively. At each decoding step, the model receives the encoder's hidden states, and the previously generated tokens o=“[pad]o₁ o₂ o₃ . . . oⱼ₋₁” and predicts the next token of with the highest probability. The decoding process stops when one of the following conditions is met: The maximum number of generated tokens N is reached, or the model generates the end-of-sequence token “[eos]”. Let the total number of generated tokens be \hat{N}, the final interpretation e is formed by concatenating the tokens from the second to the last generated token:

$$e = \begin{matrix}\text{"} {o}_{2} & {o}_{3} & {o}_{4} & … & {o}_{\hat{N}}\end{matrix} \text{"}$$

What is claimed is:

1. A method for automatic interpretation of semantic search results based on relevance levels, the method comprising four main steps:
Step 1: reference data retrieval; wherein inputs comprise a reference dataset, and a set of query-passage pairs requiring automatic relevance annotating; the reference dataset contains both input information (query-passage pairs) and output information (relevance level annotations and corresponding interpretations), each of a point of the reference data is labeled with a relevance level: 1 indicates relevant, and 0 indicates not relevant, these labels are pre-annotated by annotators in data analysis to suite intended applications or business requirements, in addition to relevance level evaluating, the annotators are required to provide textual explanations describing why a given query-passage pair is or is not relevant, an output of Step 1 is a set of examples, i.e., data items in the reference dataset that are semantically similar to a given query-passage pair, this step comprises the following sub-steps:
Context encoding: This sub-step employs a bidirectional context encoder model E to transform each input text into an embedding vector that represents its semantic information, let the reference dataset S include N samples:
$$S = \{ {s}_{1} , {s}_{2} , … , {s}_{N} \} = \{ ( {q}_{1} , {p}_{1} , {e}_{1} , {r}_{1} ) , ( {q}_{2} , {p}_{2} , {e}_{2} , {r}_{2} ) , … , ( {q}_{N} , {p}_{N} , {e}_{N} , {r}_{N} ) \}$$
Each query-passage pair (qᵢ, pᵢ) is encoded by the model E into a context embedding vᵢ, embeddings of all samples form a reference matrix M_{S}:
$${M}_{S} = [ {v}_{1} , {v}_{2} , … , {v}_{N} ] = E ( S ) = E ( \{ ( {q}_{1} , {p}_{1} ) , ( {q}_{2} , {p}_{2} ) , … , ( {q}_{s} , {p}_{s} ) \} )$$
Similarly, the new query-passage pair (q, p) to be annotated is encoded into a vector v:
$$v = E ( p , q )$$
Dot product similarity: The embedding v is compared with all embeddings in the reference matrix M_{S} using a dot product operation to obtain a similarity score vector D:
$$D = [ {d}_{1} , {d}_{2} , … , {d}_{i} , … , {d}_{N} ] = {M}_{S} v = [ {v}_{1} . v , {v}_{2} . v , … , {v}_{i} . v , … , {v}_{N} . v ]$$
where each element dᵢ represents the similarity score between the current pair (p, q) and a reference sample (qᵢ, pᵢ) in S;
Example selection: The selection module identifies k samples from S that are most similar to (p, q) based on the computed similarity scores, to avoid bias toward a single relevance class, the selection module ensures that
$$\frac{k}{2}$$
samples are chosen from relevant data (rᵢ=1) and
$$\frac{k}{2}$$
samples from non-relevant data (rᵢ=0), according to a highest similarity values dᵢ, the final selected set is defined as:
$$Top - ( \frac{k}{2} ) ( \{ {s}_{i} ∈ S \vert {r}_{i} = 1 \} , {v}_{i} . v ) ⋃ Top - ( \frac{k}{2} ) ( \{ {s}_{i} ∈ S \vert {r}_{i} = 0 \} , {v}_{i} . v )$$
where Top-k({x₁, x₂, . . . , x_{N}}, f(X)) denotes a function that retrieves the k elements with the highest scores according to f(x) from the set {x₁,x₂, . . . , x_{N}}; in this case, f(x) represents the dot product between the embedding of a reference sample vᵢ and the embedding of the current input v, as precomputed and stored in D; After this step, the result is a balanced example set containing
$$\frac{k}{2}$$
relevant and
$$\frac{k}{2}$$
non-relevant samples, used as reference examples in the subsequent data generation step;
Step 2: interpretive data generation, automatically generate training data using large language models (LLMs), given each current query-passage pair and the reference examples obtained from Step 1, construct a prompt to be fed into the large language model, the LLM then produces an interpretation and a relevance evaluation for each input pair, this step includes three sub-steps:
Prompt construction: A prompt is a natural-language instruction document designed to guide the large language model in producing outputs that satisfy user-defined requirements, the prompt has a structured composition including the following components:
+ System instruction: specifies a role or perspective that the large language model must adopt, and general behavioral constraints;
+ User instruction: defines a specific task that the model must perform;
+ Output constraint: defines a required output format (e.g., JSON, YAML);
+ Examples: provide reference samples obtained from Step 1 for in-context learning;
+ Target data: contains the current query and passage pair to be annotated;
Large Language Model processing: an entire constructed prompt is fed into a pretrained large language model, which automatically generates a desired output, each query-passage pair is processed multiple times, since LLM outputs may vary across different generations;
Post-processing: A post-processing module is applied to ensure quality and consistency of the generated dataset, this step filters out invalid or inconsistent samples based on the following criteria:
+ Format validation: to remove results that do not satisfy the required output format or are missing required fields such as “explanation” or “label”;
+ Label consistency filtering: for input pairs that produce multiple outputs across different LLM runs, only samples with consistent or majority labels are retained;
Step 3: training an interpretive model, this step is configured to fine-tune a smaller language model based on an encoder-decoder architecture using the training dataset prepared in Step 2, the input of this step is the training dataset generated from Step 2, and the output is a fine-tuned interpretive model;
Before training, the dataset is reformatted into two text sequences for each sample:
+ Input text sequence: a concatenated text that combines the query q and the passage p in the format:
$$i = “ {i}_{1} {i}_{2} {i}_{3} … {i}_{m} ” = “ q \vert p ”$$
where m denotes the number of tokens in the input sequence;
+ Output text sequence: a concatenated text containing a relevance label r and an explanation e in the following format:
$$o = “ {o}_{1} {o}_{2} {o}_{3} … {i}_{n} ” = \{ \begin{matrix}“ [ spec 1 ] e [ eos ] ” if r = 1 \\ “ [ spec 0 ] e [ eos ] ” if r = 0\end{matrix}$$
where [spec0] and [spec1] are special tokens added to a model vocabulary to indicate a relevance class (o₁=[spec0] or [spec1]), n is a number of tokens in the output sequence; [eos] marks an end of the sequence;
The interpretive model is based on an encoder-decoder language model architecture, the encoder receives an input token sequence “i₁ i₂ i₃ . . . m” and transforms it into a set of hidden vectors representing semantic features of the input [vi₁, vi₂, vi₃, . . . , viₘ, the decoder receives a shifted target sequence “[pad]o₁ o₂ o₃ . . . oⱼ₋₁” (where [pad] is a special start token) and predicts a next token oⱼ at each step;
Each training epoch consists of the following operations:
Forward propagation: The input text sequence is first encoded by the encoder into contextual hidden vectors, the decoder then receives both the encoder's hidden states and shifted output tokens, generating one token prediction at a time, at each decoding step j∈[1, n], the decoder outputs a probability distribution over the vocabulary representing the likelihood of each possible next token oⱼ;
Loss computation: After producing the predicted sequence, the model's output is compared with the ground truth to compute a loss value, the training uses the cross-entropy loss function, defined as:
$$L = - \frac{1}{n} {\sum }_{j = 1}^{T} log ( {\hat{o}}_{t , {o}_{j}} )$$
where n is a number of tokens in the output sequence; oⱼ is a target token at position j; ô_{t,o}_{ⱼ} is a predicted probability of the target token oⱼ at step j;
Backpropagation: During backpropagation, gradients of a loss function are computed and propagated backward through the decoder and encoder layers;
The training process is repeated for multiple epochs (full iterations over the entire training dataset) until convergence is achieved—i.e., when the loss function no longer decreases significantly or reaches a predefined threshold;
Step 4: generating interpretations and computing relevance levels, to perform inference using the fine-tuned interpretive model obtained from Step 3, the input to this step is a set of query-passage pairs that require relevance evaluation, the output includes a normalized relevance level for each input pair, and a corresponding textual interpretation explaining the relationship between the query and the passage;
The inference process follows a forward propagation procedure corresponding to that used in Step 3, the encoder input is the concatenated text sequence
$$i = “ {i}_{1} {i}_{2} {i}_{3} … {i}_{m} ” = “ q \vert p ”$$
where q denotes a current query and p denotes a current passage;
The decoder receives two inputs: the encoded hidden representations from the encoder, and the shifted target sequence, initially containing only a special token=“[pad]”;
The first decoder output is used to compute a relevance score between the query q and the passage p, only two special tokens are considered: [spec0] and [spec1], representing the two relevance classes, let the unnormalized logits (i.e., decoder output scores) corresponding to these tokens be ŷ_{1,[spec0]} and ŷ_{1,[spec1]}, a normalized relevance level \hat{r} (ranging from 0 to 1) is computed as follows:
$$\hat{r} = \frac{{e}^{{\hat{y}}_{1 , [ s pec 1 ]}}}{{e}^{{\hat{y}}_{1 , [ spec 0 ]}} + {e}^{{\hat{y}}_{1 , [ s pec 1 ]}}}$$
In practical semantic search systems, this value \hat{r} can be used directly as the relevance confidence level, the inference process may terminate at this point when textual interpretation is not required or when the system demands real-time response, when interpretive output is desired, the decoding process continues iteratively, at each decoding step, the model receives the encoder's hidden states, and the previously generated tokens o=“[pad]o₁ o₂ o₃ . . . oⱼ₋₁” and predicts the next token of with a highest probability, the decoding process stops when one of the following conditions is met: a maximum number of generated tokens N is reached, or the model generates an end-of-sequence token “[eos]”, let the total number of generated tokens be \hat{N}, the final interpretation e is formed by concatenating the tokens from the second to the last generated token:
$$e = “ {o}_{2} {o}_{3} {o}_{4} … {o}_{\hat{N}} ” .$$
